(19) United States
(12) Patent Application Publication
(10) Pub. No.: US 2023/0165254 A1
(43) Pub. Date: Jun. 1, 2023

(54) METHOD FOR PREVENTIVE TREATMENT OF A CROP PLANT TO LIMIT THE LOSS OF DRY MATTER DUE TO ABIOTIC AND/OR BIOTIC STRESS

(71) Applicant: Elicit Plant, Moulins-Sur-Tardoire (FR)

(72) Inventors: Aymeric MOLIN, Moulins-Sur-Tardoire (FR); Charlène BOUSSIRON, Moulins-Sur-Tardoire (FR); Solange VILLETTE, Moulins-Sur-Tardoire (FR); Geoffrey DELAGE, Moulins-Sur-Tardoire (FR); Caroline EVERAERE, Moulins-Sur-Tardoire (FR)

(73) Assignee: Elicit Plant, Moulins-Sur-Tardoire (FR)

(21) Appl. No.: 17/920,344

(22) PCT Filed: Apr. 19, 2021
(86) PCT No.: PCT/FR2021/050683

§ 371 Date: Oct. 20, 2022

(30) Foreign Application Priority Data
Apr. 20, 2020 (FR) 2003949

(51) Int. Cl. A01N 45/00; A01P 21/00; A01N 25/30; A01N 25/04

(52) U.S. Cl. CPC A01N 45/00; A01P 21/00; A01N 25/30; A01N 25/04

(57) ABSTRACT

The invention relates to a method of preventive treatment of a cultivated plant to limit the loss of dry matter linked to abiotic and/or biotic stress, consisting of applying to the plant, before the appearance of said abiotic and/or biotic stress, a slurry comprising:
water; and
a base,
said base comprising at least one surfactant and a mixture of phytosterols comprising β-sitosterol.

### FIELD OF THE INVENTION

The invention relates to the field of cultivated plants, in particular in fields, and to the prevention of the harmful effects linked to exposure to abiotic and/or biotic stresses in said cultivated plants, in particular the loss of dry matter, i.e., per hectare, and the decrease in yield. Thus, the invention relates to a method of preventive treatment of a plant in cultivation to limit the loss of dry matter linked to abiotic and/or biotic stress. It also relates to a slurry comprising at least one surfactant and a mixture of phytosterols for carrying out the process, as well as a base for the manufacture of said composition.

### PRIOR ART

Plants, that is to say crops, and especially ornamental plants, are subjected to various stresses. In particular, plants are constantly exposed to their environment and cannot escape abiotic stressors (drought, cold, frost, salinity, etc.). At the same time, they are also exposed to biotic stressors, i.e., stress resulting from the harmful action of a living or pest organism (viruses, fungi, bacteria, insects, pests).

In general, these abiotic and biotic stresses cause morphological, physiological, biochemical and molecular changes in plants, resulting in a reduction in the yield per hectare of crops, i.e., a reduction in the production of dried material.

In other words, a plant cultivated, for example in fields, is subjected to these various stresses having in particular the effect of a decrease in the production of dry matter by the plant compared to a plant cultivated under optimal conditions (controlled conditions of water intake, day/night period, no exposure to abiotic and/or biotic stresses).

To fight against abiotic stress, in particular water stress (or drought), farmers have adapted by simplifying their rotations and favoring winter crops. The first consequence of this simplification is an increase in the risk of resistance to adventive species (weeds) and pests to phytopharmaceutical products but also an increase in the risk of water pollution by large applications of products at the same time of the year. The second consequence is the disproportion of cultivation of starch-producing plants (straw cereals in particular) compared to protein-producing plants (legumes). In addition, to fight against drought, farmers resort to extensive irrigation of crops, which creates ecological and economic problems.

Regarding the fight against biotic stresses, farmers use chemical or biocontrol phytopharmaceutical products that call on natural mechanisms. However, the use of chemicals in agriculture is controversial in view of their potential toxicity for human health and for the environment, it is therefore necessary to limit as much as possible the quantity used of these products while optimizing their effects as much as possible.

Curative treatments have been proposed which consist in applying to plants a mixture of surfactant and/or phytosterol after exposure to biotic or abiotic stress. For example, documents EP 2,183,959 or even JP S51 57556 only describe the application of a surfactant. The documents GRIEBEL et al., or VRIET et al., describe the exclusive application of at least one phytosterol. Documents WO 2018/229710, CN 103,563,929, FR-A-3,069,756 and FR-A-3,069,757 describe the application of a mixture of phytosterol and a surfactant.

The application of compositions to plants exposed to a biotic or abiotic stress before the appearance of this stress has also been proposed, i.e., as a preventive treatment. For example, the document EBAD et al., describes experiments during which sunflower seeds are immersed in a composition comprising only β-sitosterol before being exposed to salt stress (abiotic stress). This results in a decrease in the harmful effects of salt stress on plant growth.

Finally, the documents CN 103,563,929, JP H07 89808 or KR 2011 0124174 describe methods for the curative treatment of plants subjected to biotic stress consisting in applying a mixture of a phytosterol and a surfactant as an auxiliary agent of said composition. However, the compositions described in these documents do not make it possible to preserve the expected yields.

Similarly, one of the means currently implemented to reduce the yield gap between cultivation in fields and cultivation in optimal conditions is the genetic improvement of the plant (genetically modified organism or GMO), which allows it to go beyond its genetic potential. However, this method of modifying the genome of plants remains controversial and their cultivation is prohibited in certain countries, including France.

Consequently, the problem which the invention proposes to solve is that of developing a formulation and a method for treating a plant cultivated from an unmodified seed in order to effectively reduce the loss of dry matter induced by exposure to abiotic and/or biotic stress and which does not exhibit the aforementioned drawbacks.

### DISCLOSURE OF THE INVENTION

The Applicant has found that, quite surprisingly, a slurry based on a mixture of phytosterols, including β-sitosterol, and at least one surfactant, applied to the plant in cultivation as a preventive measure, that is—i.e., before the stress occurs, made it possible to reduce the harmful effects of abiotic and/or biotic stresses, in particular the loss of dry matter and therefore of the yield per hectare.

In particular and unexpectedly, the mixture and the treatment method according to the invention induce an overall strengthening of the vigor of the plant. Depending on environmental conditions, this effect may result in maintaining an optimum yield while the crop is placed under stressful conditions. In other words, it is about preserving the yields, in particular the production of dry matter, expected for each pedo-climatic context. According to an essential characteristic, the slurry and the method of treatment according to the invention do not induce an increase in the yield when the plant is cultivated under optimal conditions. In other words, the invention does not allow the plant to exceed its genetic potential in the absence or in the presence of exposure to stress. The description and the examples presented below show in particular that the effects of the invention result in an adaptation of the plant (physiology, growth, metabolism, etc.) which enables it to fight against abiotic and/or biotic stresses and to maintain the production of dry matter.

The invention relates to a method of preventive treatment of a cultivated plant to limit the loss of dry matter linked to abiotic and/or biotic stress, consisting of applying to the plant, before the appearance of said abiotic and/or biotic stress, a slurry comprising:
water; and
a base comprising at least one surfactant and a mixture of phytosterols comprising β-sitosterol.

For the purposes of the invention, the expression “cultivated plant” is opposed to a plant living naturally and, consequently, designates all the plants that man is capable of cultivating, i.e., sowing, planting, and exploiting.

Advantageously, for the purposes of the invention, the plant is cultivated in fields or under controlled conditions, for example in hydroponics, in pots, in a greenhouse; preferably the plant according to the invention is cultivated in fields.

For the purposes of the invention, the term “slurry” refers to the base according to the invention diluted in water or in a solution comprising water and one or more active ingredients. In other words, the slurry comprises the base of the invention, water and optionally one or more active ingredients.

In general, abiotic stress is the cause of a decrease in the yield/production of dry matter and results from drought (lack of water or water stress), extreme temperatures (heat stress), excess water (inundation or “flooding”), frost, wind, soil salinity (salt stress), ultraviolet radiation, insufficient access to certain nutrients, soil with stressful characteristics (chemical composition, redox potential, etc.), or mechanical injury, advantageously drought and/or extreme temperatures.

According to one particular embodiment, the abiotic stress is water stress. According to another particular embodiment, the abiotic stress is heat stress.

For the purposes of the invention, the phrase “before the onset of abiotic stress”, in particular with regard to water stress, refers to the period when the useful water reserve in the soil is correctly filled, that is to say the period between the moment when the useful water reserve is completely full (field capacity) and the moment of wilting point.

For the purposes of the invention, the phrase “before the appearance of abiotic stress”, in particular with regard to thermal stress (or extreme temperatures), refers to the period before the frost-sensitive and/or scalding point according to each species of plant and each stage of development of these species. In other words, these are temperatures unfavorable to the growth and development of the plant, regardless of any other growing conditions, for example, the water intake.

With regard to drought, the Applicant has observed that the mixture according to the invention, applied as a preventive measure to the cultivated plant, i.e., before the abiotic stress occurs, made it possible to induce a closure of the stomata and therefore a decrease in evapotranspiration. Consequently, water consumption by the plant is reduced without affecting the yield, i.e., the production of dry matter.

In other words, the invention also relates to a method for reducing the consumption of water by a plant cultivated under conditions of water stress, consisting of applying the slurry described above to said plant before the appearance of the water stress.

In practice, the biological mechanisms brought into play by the slurry according to the invention, in particular phytosterols and therefore β-sitosterol, lead to a stimulation of the plant's vigor which offers the plant better resistance to water stress:
stimulation of root system development makes it possible to enlarge the water reservoir accessible to the plant;
the message sent by β-sitosterol in the plant induces partial closure of the stomata, thus limiting water loss by evapotranspiration.

For the purposes of the invention, “stimulation of the vigor of the plant” refers to, for example, a stimulation of various metabolic pathways of the plant which offer better resistance of the plant to water stress.

Advantageously, the biological mechanisms described above lead to improving the overall vigor of the plant.

The size of the water reservoir accessible to the plant and the rate of consumption of this reservoir are therefore modulated by signals whose transmission involves phytosterols, in particular β-sitosterol. These two mechanisms lead to an optimization of the consumption by the plant of the water to which it has access.

More specifically, an effect of water stress tolerance is observed, in particular induced by β-sitosterol as used in the invention as well as by the application of the slurry before exposure to stress.

According to one particular embodiment, the biotic stress at the origin of a decrease in the yield/production of dry matter may result from the harmful action of a living organism on the cultivated plants, whether it be a fungal and/or a bacterial and/or a viral infection and/or an attack by pests and/or competition with weeds.

By way of example, a fungal infection of the plant is mildew on vines, tomatoes, potatoes or else septoria on wheat, rynchosporia on barley or powdery mildew on straw cereals and grapes; a bacterial infection of the plant is crown gall, canker or even fire blight; a viral infection of the plant may be mosaics or even dwarfing yellows; pests capable of attacking a cultivated plant are aphids, flea beetles or even weevils.

In particular, the slurry according to the invention makes it possible to reduce the intensity of a fungal disease, advantageously without affecting its frequency.

For the purposes of the invention, “before the appearance of biotic stress”, in particular in the case of a fungal infection, refers to the period before the appearance of the first symptoms, for example, before the appearance of the first spots on the leaves and/or stems of the cultivated plant.

For the purposes of the invention, the expression “intensity of the fungal disease” refers to the average of the intensity of the disease on all the leaves of the cultivated plant. The intensity of the disease on a leaf is the area of the leaf covered by the disease.

For the purposes of the invention, the expression “frequency of fungal disease” refers to the number of leaves upon which the disease/appearance of spots is observed.

It is apparent from the foregoing that the slurry according to the invention applied before the appearance of a plant infection, in particular of a fungal infection, ensures a reduction in the area of the spot/leaf discoloration compared to a plant not having received the preventive treatment according to the invention.

The Applicant has also observed that the slurry according to the invention improves the growth and development of the plant, and particularly of the young seedling when the slurry is applied before the onset of stress. In particular, these improvements are all the more advantageous when the slurry is applied by soaking the seed.

The invention therefore also relates to a method for stimulating the growth and development of young plantlets, consisting in applying the mixture described above before the onset of abiotic and/or biotic stress, preferably by soaking the seed. Therefore, the method according to the invention makes it possible to limit the time of exposure of the young plantlet to abiotic and/or biotic stresses. Furthermore, the effect of the product applied by soaking the seed lasts over time, since the plants treated with the composition of the invention are more tolerant to abiotic and/or biotic stress.

In practice, the young seedling is more fragile than the adult plant with regard to abiotic and/or biotic stresses. A young plantlet that has received a treatment with the mixture according to the invention reaches a state of so-called complete maturity (“adult” state) more quickly than a plantlet which has not received this treatment. Advantageously, the surfactant included in the slurry according to the invention facilitates passage through the barrier of the seed's integuments, or even the rupture of its integuments, and thus accelerates germination. Then, the exogenous intake of the mixture of phytosterols, in particular β-sitosterol, makes it possible to stimulate the growth and development of the seedling.

It follows from the above that the period during which the seedling could be subjected to stress is reduced.

The fact that the compounds according to the invention are not products with a specific activity, for example, a fungicide or even a biocide, makes a broad-spectrum use possible on a large number of crops to be considered, which in particular, may improve protection and therefore the profitability of minor crops for which the number of plant protection products available is almost zero.

In practice, the slurry according to the invention is applied by spraying the leaves, sprinkling, irrigation, soaking the seed, coating the seed, drip or gravity watering the cultivated plant, by addition to a culture medium in hydroponics or by even immersion.

For the purposes of the invention:
“Foliar spray” refers to a pressurized slurry projection forming a large number of microdroplets which then cover the upper side and/or bottom of the leaf;
“irrigation” refers to a supply of water in the soil solution captured by the root system of the plant; and
“Soaking the seed” refers to the immersion of the seed in a solution comprising the composition.

Advantageously, the slurry is applied by foliar spraying at a rate of 0.1 L/ha to 15 L/ha, preferably at a rate of 1 L/ha to 5 L/ha on the cultivated plant, preferably at the ground cover stage by the leaves of the plant. According to one particular embodiment, the slurry is applied as many times as necessary to combat all the abiotic and/or biotic stresses to which the cultivated plant is subjected during its life, i.e., until it becomes desiccated or wilted.

Advantageously, the slurry according to the invention is applied only once by foliar spraying and/or irrigation and/or soaking the seed.

According to one particular embodiment, the cultivated plant is a chlorophyll plant, advantageously selected from the group comprising the plants of large crops of cereals, oilseeds and protein crops; viticulture; roots and tubers; horticulture; sod; vegetable gardens; aromatics and spices; arboriculture or industrial cultivation of plants intended for the production of a raw material with a view to its transformation.

Preferably, the cultivated plant is selected from the group comprising soybeans, corn, barley, millet, Hungarian grass, miscanthus, panicum, sorghum, peanuts, wheat, rapeseed, sunflower, protein peas, field peas, field beans, lupine, flax, truncated alfalfa, grapes, beets, potatoes, beans, lettuce, parsley, rice, radishes, fruit trees and ornamental plants.

According to one embodiment, the mixture of phytosterols comprises β-sitosterol, campesterol, stigmasterol and brassicasterol.

Advantageously, the β-sitosterol represents at least 30% by mass of the mixture of phytosterols, preferably at least 35%, the complement to 100% comprising where appropriate, in particular campesterol, stigmasterol and brassicasterol.

By way of example, a mixture of phytosterols according to the invention corresponds to an extract of phytosterols obtained from oleaginous seeds such as soybean, pine, sunflower or rapeseed seeds. Mention may be made, by way of example, of the raw material corresponding to the CAS number 949109-75-5.

According to one embodiment, the at least one surfactant is selected from the group comprising anionic surfactants, advantageously those whose polar head is a carboxylate, a sulfonate or a sulfated alcohol; cationic surfactants, advantageously those whose polar head is an amine, a quaternary amine or a quaternary ammonium ester; amphoteric surfactants, advantageously betaine or phospholipid derivatives; neutral surfactants, advantageously ethoxylates, alkanolamines, alkylglucamides, polyol esters, alkyl-mono and alkyl-poly-polyglucosides or polyol ethers; natural surfactants, advantageously soy lecithin or surfactants derived from amino acids; and/or surfactants synthesized from natural raw materials, advantageously polyol derivatives, preferably sugar and fatty acid esters.

Advantageously, the sugar and fatty acid esters are sucrose stearate, sucrose palmitate and their polyesters.

According to another particular embodiment, the method according to the invention consists in applying a slurry to the plant, before the appearance of an abiotic and/or biotic stress, which comprises:
a mixture that advantageously comprises β-sitosterol as at least 30% by mass of the mixture, and campesterol, stigmasterol and brassicasterol; and
at least one surfactant comprising sucrose stearate.

Advantageously, the at least one surfactant as described above is in the form of a mixture comprising sucrose stearate and sucrose palmitate.

According to one particular embodiment, the phytosterols/surfactant mass ratio of said slurry's mixture used in the process according to the invention is between 0.01 and 5, advantageously between 0.1 and 2.5.

According to another aspect, the invention relates to a slurry comprising in particular water and a base comprising at least one surfactant and a mixture of phytosterols comprising β-sitosterol, for the implementation of the method as described above, the composition being that described above.

According to one particular embodiment, the base represents between 1 ppm and 20% by mass of the slurry, advantageously between 1 ppm and 10%, the complement to 100% being water or a mixture comprising water and one or more active ingredients.

According to another aspect, the invention relates to a base for the manufacture of the above composition. In one particular embodiment said base is in the form of an oil-in-water emulsion. The particle (or oil droplets) size in the emulsion is less than 500 μm comprising:
an aqueous phase representing between 60% and 95% by mass of the base and advantageously comprising, a preservative;
an oily phase representing between 5% and 40% by mass of the base comprising:
at least one surfactant; and
a mixture of phytosterols comprising β-sitosterol,
the mass ratio of the phytosterol/surfactant mixture of said base being between 0.01 and 5, advantageously between 0.1 and 2.5.

In this particular embodiment, the base is in the form of an emulsion consisting of particles constituting the oil phase and comprising the phytosterol mixture. The size of these particles are less than 500 μm, advantageously less than 200 μm, preferably less than 100 μm, in particular less than 50 μm, even better if less than 10 μm.

According to one particular embodiment, the size of the particles is between 0.1 and 10 μm.

The term “size” refers to the largest dimension of the particles, namely, the mean diameter by volume, determined by laser diffraction.

Advantageously, the size of the particles according to the invention is less than the size of the stomata of a plant (on the order of 10 μm) in order to facilitate their penetration into said plant. According to one particular embodiment of the invention, the aqueous phase further comprises a preservative, advantageously selected from the group consisting of benzyl alcohol or one of its salts, benzoic acid or one of its salts, dehydroacetic acid or one of its salts, salicylic acid or one of its salts, and sorbic acid or one of its salts. Preferably, this preservative represents between 0.1% and 5% by mass of the base.

It is apparent from the foregoing that the slurry according to the invention penetrates the plant through the stomata and/or by crossing the cuticle and/or by absorption through the root system of the cultivated plant.

In practice, the slurry applied to the plants is obtained by diluting the base.

As will be seen below, the use of the base constituting the slurry in the form of a stable emulsion combined with the use of a surfactant/phytosterol mixture in the form of particles, as mentioned above, makes it possible to reduce the quantity of β-sitosterol, advantageously applied in the field, while remaining effective with respect to abiotic stresses, especially water stress.

In practice, the aqueous phase included in the base represents between 60% and 95% by mass of the base, advantageously between 70% and 90%, preferably between 75% and 88%.

According to one particular embodiment, the oil phase represents between 5% and 40% by mass of the base, advantageously between 10% and 30%, preferably between 12% and 25%.

Unexpectedly, the Applicant has found that the surfactant according to the invention modifies the state of the cuticle to make it permeable, that is to say it makes it possible for the mixture of phytosterols to penetrate so as to reach the internal elements of the leaf, or the plant, for example, the plant cells.

According to one embodiment, the phytosterols and surfactant mixture according to the invention are combined with at least one active ingredient.

For the purposes of the invention, the term “active” refers to a biological product making it possible for the plant to fight against abiotic and/or biotic stresses, advantageously:
a phytopharmaceutical product such as a growth regulator, fungicide, fungistat, bactericides, bacteriostat, insecticide, acaricide, parasiticide, nematicide, talpicide or even a herbicide;
a biocontrol product based on natural mechanisms allowing plants to fight against fungal infections, bacterial infections, viral infections, attack by pests and/or competition with weeds; preferably fungicides, fungistats, bactericides, bacteriostats, insecticides, acaricides, parasiticides, nematicides, talpicides or even herbicides; and or
nutrients such as trace elements or fertilizers.

As already mentioned, slurry refers to the base according to the invention diluted in water or in a solution comprising water and one or more active ingredients.

As mentioned previously, the traditional treatment of cultivated plants consists in particular of applying active products (a phytopharmaceutical product and/or a biocontrol product and/or a nutrient) on the cultivated plant where they only exert an action through an interaction with the surface of the plant. They do not penetrate, or they penetrate very little by passive diffusion into the plant.

Unexpectedly, the Applicant has found that the combination of phytosterols and the surfactant according to the invention with at least one active ingredient facilitates the diffusion, the passive penetration of the active ingredient into the plant cell by means of the cuticle and plant cell membrane passage mechanisms as previously described. Therefore, the slurry according to the invention makes it possible for a higher concentration/quantity of the active ingredient to enter the plant. Provided that the spray is applied before the stress occurs, a systemic action of the active ingredient in the plant is observed and thus better control of abiotic and/or biotic stresses.

In addition, the slurry makes it possible to reduce the doses of active ingredients used while guaranteeing better effectiveness of these ingredients.

The phytosterol mixture as well as the surfactant(s) have the same characteristics as described above.

According to one particular embodiment, the oil phase represents between 0.5% and 10% by mass of the base, advantageously between 0.5% and 7%, preferably between 1% and 5%.

Advantageously, in the phytosterol mixture, β-sitosterol is present in a higher amount than campesterol, stigmasterol or brassicasterol (β-sitosterol >campesterol; β-sitosterol >stigmasterol; β-sitosterol >brassicasterol).

Preferably, β-sitosterol is present in higher amounts relative to campesterol in the mixture (β-sitosterol >campesterol).

In one preferred embodiment, β-sitosterol comprises at least 30% by mass of the mixture, campesterol and stigmasterol each comprise at least 15% by mass of the mixture, brassicasterol comprises at least 1% by mass of the mixture.

The base according to the invention allows an effective exogenous supply of phytosterols, in particular β-sitosterol, possibly combined with active ingredient(s), via the combination of a suitable formulation with a phytosterol vectorization system in the form of particles of particular size, as mentioned above.

For the purposes of the invention, “vectorization of phytosterols” refers to the transport of phytosterols, which are hydrophobic, by means of the aqueous phase.

To promote penetration of the phytosterols, advantageously phytosterols combined with the active ingredient, through the cuticle, the surfactant advantageously represents between 0.2% and 30% by mass of the base, preferably between 1% and 20%, in particular between 2.5% and 15%.

Unexpectedly, the Applicant has found that the penetration of the base according to the invention through the cuticle was further improved by using a mixture comprising sucrose stearate and sucrose palmitate as surfactant.

In one preferred embodiment, the surfactant is a mixture comprising:
between 20% and 80% by mass of the surfactant, advantageously 70%, of sucrose stearate, the monoester content of which is between 20% and 80% by mass of the sucrose stearate, advantageously 70%, the remainder being a mixture of di-, tri- and/or polyesters; and
between 20% and 80% by mass of the surfactant, advantageously 30%, of sucrose stearate, the monoester content of which is between 20% and 80% by mass of the sucrose stearate, advantageously 30%, the remainder being a mixture of di-, tri- and/or polyesters; and

According to one particular embodiment, the base according to the invention further comprises at least one component selected from the group comprising:
at least one fluidifying agent selected from the group comprising a polyethylene glycol with a weight average molecular weight of between 200 and 8000 Da, advantageously between 200 and 1000 Da, preferably 400 Da; the fluidifying agent advantageously represents between 1% and 15% by mass of the base, advantageously between 2% and 8%; and or
at least one phytosterol (or fatty substance) solubilizing agent selected from the group comprising oleic alcohol; oleic acid; linoleic acid and a vegetable oil, advantageously soybean oil, sea buckthorn oil, corn oil, rapeseed oil, sunflower oil; the solubilizing agent advantageously represents between 2 and 30% by mass of the base, advantageously between 4 and 15%; and/or
at least one wetting agent selected from the group comprising a mixture of methyl esters advantageously comprising methyltetradecanoate, methyloctadecanoate and methylhexadecanoate, the wetting agent advantageously represents between 0.1% and 5% by mass of the base; and or
at least one chelating agent, selected from the group comprising natural chelating agents, advantageously sodium phytate or chelating agents based on amino acids; and synthetic chelating agents, advantageously 2,2′-bipyridine, dimercaptopropanol, ethylene glycol-bis-(2-aminoethyl)-N,N,N′,N′-tetraacetic acid (EGTA), ethylenediaminetetraacetic acid (EDTA), nitrilotriacetic acid, iminodiacetic acid, salicylic acid or also triethanolamine, preferably EDTA; the chelating agent advantageously represents between 0.01% to 5% by mass of the base; and/or
at least one preservative, advantageously benzyl alcohol; the preservative advantageously represents between 0.1% and 5% by mass of the base.

According to one particular embodiment, the base according to the invention comprises, advantageously consists of:
0.2% to 30% by mass of the base, of at least one surfactant, advantageously a mixture comprising sucrose stearate and sucrose palmitate;
0.5% to 10% by mass of the base, of a mixture of phytosterols comprising β-sitosterol, advantageously β-sitosterol represents at least 30% by mass of the mixture, the remainder comprising a mixture of campesterol, of stigmasterol and brassicasterol;
1% to 15% by mass of the base of a fluidifying agent, advantageously polyethylene glycol with a number-average molecular mass (Mn) of between 200 and 8000 Da, advantageously between 250 and 1000 Da, preferably 400 Da; or a vegetable oil as mentioned above
0.1 to 5% by mass of the base of a wetting agent, advantageously a mixture of methyl esters preferably comprising methyltetradecanoate, methyloctadecanoate and methylhexadecanoate;
0.1 to 5% by mass of the base of a preservative, advantageously benzyl alcohol;
0.01% to 5% by mass of a natural or synthetic chelating agent base, advantageously as described above, preferably EDTA; and
the remainder being water (QSP 100% water).

In practice, the base according to the invention is applied in diluted form. In other words, the emulsion is diluted to form a slurry corresponding to the composition described above applicable to a cultivated plant, in particular applicable in fields.

Advantageously, the viscosity of the slurry according to the invention is less than or equal to 200 cP, strictly advantageously greater than 1 cP and less than or equal to 100 cP. According to the invention, the viscosity is measured using a Brookfield viscometer, HAAKE viscotester D and the measurement is carried out at room temperature with the L1 needle at 100 rpm.

Advantageously, the pH of the slurry according to the invention is between 5 and 8; advantageously between 6 and 7.

According to another aspect, the invention relates to a method of manufacturing the base described above comprising the following steps:
preparing an oil phase consisting of mixing the phytosterols comprising β-sitosterol with at least one surfactant, the phytosterols/surfactant mass ratio being between 0.01 and 5, advantageously between 0.1 and 2.5;
preparing an aqueous phase comprising, advantageously, a preservative;
mixing the oil phase and the aqueous phase;
mechanically stirring the mixture, i.e., the oil phase and the aqueous phase, until a particle size of less than 500 μm is obtained.

According to one particular embodiment of the invention, the preservative is as described above.

Advantageously, the preparation of the oil phase contains a preliminary step of mixing the phytosterols with at least one fluidifying agent, and/or at least one phytosterol solubilizer, and/or at least one wetting agent, as described above, at a temperature that a person skilled in the art will be able to adapt according to the components so that the mixture of phytosterols and surfactants is liquid and that the process makes it possible to manufacture an emulsion.

Advantageously, the aqueous phase is heated to a temperature that a person skilled in the art will know how to adapt according to the components included in the aqueous phase.

The base, the slurry comprising the base, and the method for manufacturing the base according to the invention, have the advantages of corresponding in all respects to the demands of the company in terms of phytopharmaceutical products:
Applicable in the field while comprising an effective concentration of phytosterols to stimulate the growth of the plant in cultivation and to respond to abiotic and/or biotic stress;
Respect for the environment;
Lack of danger for humans;
Wide spectrum of use in terms of varieties of plants in cultivation;
No induced resistance;
Improvement of environmental conditions;
Economic interest;
Regulatory interest.

The invention and the advantages which result therefrom will emerge more clearly from the following figures and examples given in order to illustrate the invention and in a non-limiting manner.

### BRIEF DESCRIPTION OF THE FIGURES

FIG. 1 shows the raw data of the evolution of the water resistance (W/R) of the soil over 24 hours of a soybean crop treated with the slurry according to the invention (base diluted to 3% by mass in water) relative to a control soybean crop and the wilting point.

FIG. 2 shows the average values of the water resistance (W/R) of the soil, measured over 24 rolling hours of a soybean crop treated with the slurry according to the invention (base diluted to 3% by mass in water) relative to a control soybean crop.

FIG. 3 represents the effect of the use of the slurry according to the invention as a pre-germination treatment on the germination of sorghum seeds: percentage of germinated seeds treated (control with water, or in a slurry comprising the base according to the invention diluted to 3% by mass) based on time (days).

FIG. 4 represents the effect of the use of the slurry according to the invention as a pre-germination treatment on the radicle growth of sorghum seeds: mean size of the radicle (control with water, or in a slurry comprising the base according to the invention diluted to 3% by mass) based on time (days).

FIG. 5 represents the quantification of the intensity and the frequency of infection by mildew of young vine leaves treated or not with the mixture according to the invention.

FIG. 6 represents the quantification of the intensity and the frequency of infection by mildew of old vine leaves treated or not with the slurry according to the invention.

FIG. 7 represents the quantification of the intensity and the frequency of infection by mildew of vine leaves treated or not with the slurry according to the invention.

### DESCRIPTION OF EMBODIMENTS

1/ Preparation of the Base According to the Invention

1.1/ Composition of the Base

The composition of a base according to the invention is presented in Table 1

TABLE 1

| | % in the | |
|---|---|---|
| Chemical Nature | process | Function in the finished product |
| Mixture of phytosterols | 2 | Active |
| including β-sitosterol (at least | | |
| 30% m/m) CAS no. 949109- | | |
| 75-5 | | |
| Sucrose esters: Sucrose | 6.5 | 1) surfactant: stabilizes the |
| stearate (70% m/m) | | colloidal suspension, makes it |
| Sucrose stearate | | possible to make phytosterols |
| (30% m/m) | | soluble in water to pass through |
| | | plant membranes |
| | | 2) makes the plant cuticle |
| | | permeable |
| Water | 87.3 | Particle Vehicle (=the |
| | | active ingredient) |
| Benzyl Alcohol | 0.7 | Preservative |
| Polyethylene glycol with a | 3.5 | Fluidifying Agent |
| molar mass of 400 g/mol | | |

1.2/ Manufacturing of the Base

The base according to the invention is manufactured according to the following procedural steps:
preparation of the oil phase corresponding to the mixture of i) of the mixture of phytosterols, ii) of polyethylene glycol and iii) of the surfactant;
preparation of the aqueous phase comprising water and benzyl alcohol;
mixing the oil phase and the aqueous phase by stirring until a particle size of between 1 and 10 μm is obtained.

A dilute solution of the base (or slurry) is prepared by diluting the base according to the invention in water at a concentration of 3% by density.

2/ Evaluation of the Capacity of the Slurry According to the Invention to Reduce the Sensitivity of Soybeans in Cultivation to Water Stress

The objective of this assay is to show that the application of the slurry according to the invention on soybeans results in slowing down the consumption of water from the soil by the plant. The method consists in showing that the water reserve of the soil decreases more slowly in the treated modality than in the control modality. The assay presented was carried out under the particular pedoclimatic conditions of the experimental plots, including a water supply by irrigation, and in the year 2019.

2.1/ Materials and Methods

2.1.1/ Description of the Experimental Plot

The description of the experimental plot is presented in Table 2.

2.1.2/ Modalities Tested

| Test | Soy Test |
|---|---|
| Culture (Variety) | Soy (ES Mentor) |
| Seed density | 130 kg/ha (680,000 seeds/ha) |
| Set-up | Bands: 0.72 ha for the treated modality/ |
| | 1.44 ha for the control modality |

The description of the modalities tested is presented in Table 3.

TABLE 3

| | | Dose of base | Application |
|---|---|---|---|
| Modality | Treatment | applied | stage |
| 1 | Untreated Control (UC) | — | — |
| 2 | Slurry according | 5 L/ha | BBCH 21 |
| | to the invention | | |

The application of the slurry according to the invention is made by foliar spraying, using 80 L/ha volume of the slurry, under the following climatic conditions: temperature at 21° C., hygrometry at 75%, absence of wind.

2.1.3/ Data Collection Method

The soil water reserve is monitored using two 60 cm capacitive probes, placed in each of the modalities. The yield is measured by load cells placed in the hopper of the combine harvester.

2.1.4/ Statistical Analyses

The effect of the treatment on the variation of the soil water reserve (W/R) is studied over the 24-hour rolling periods (12:00-11:40), and then separately over the periods of photosynthetic activity (10:00-20:20) and respiration periods (20:40-9:40). The statistical analysis uses the Test for Equal Means (Student's t-test) and multiple linear regression.

2.2/ Presentation of the Results

2.2.1/ Study of the Soil Water Consumption Rate

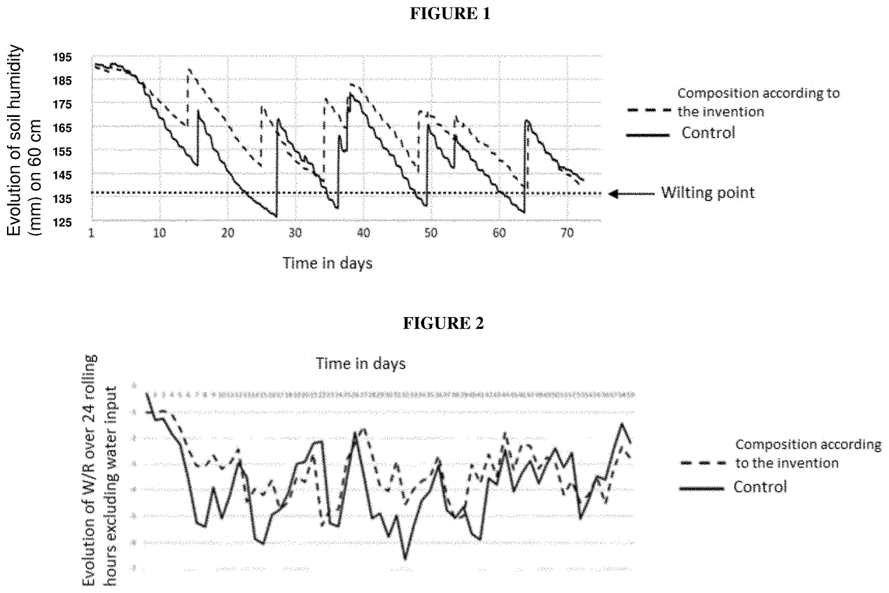

FIG. 1 represents the raw W/R variation data recorded by the probe and FIG. 2 represents the average W/R values measured over 24 rolling hours. The results of the statistical analysis are presented in Table 4 below.

TABLE 4

| W/R variation study | | | |
|---|---|---|---|
| period | 24 Hrs. | 10:00 - 20:20 | 20:40 - 9:40 |
| Slurry according | −3.2685 | −2.29 | −0.92 |
| to the invention | | | |
| Control | −3.8031 | −3.06 | −0.84 |
| ANOVA | Verified | Verified | Verified |
| Student test p-value | 0.02367 | 0.0001476 | 0.2755 |
| Conclusion (at the | Significant | Significant | Insignificant |
| threshold of 5%) | reduction | reduction | |
| | of 8 to 15% | of 15 to 40% | |

2.2.2/ Measurement of the Yield

Yield data (central area of bands) are shown in Table 5.

TABLE 5

| Modality | Mean yield (kg/ha) |
|---|---|
| Slurry according | 4589 kh/ha |
| to the invention | |
| Control | 4454 kh/ha |
| ANOVA | Verified |
| Student test p-value | 0.004401 |
| Conclusion | Significant increase on the order of 3% |

2.3/ Conclusion

This assay shows that the application of the slurry according to the invention to soybeans at an early stage of its development (BBCH21) results in a decrease in the rate of plant water consumption from the soil (curve “Composition According to the Invention” shift from the “control” curve). In addition, it was observed that the plants treated with the composition according to the invention did not reach the wilting point, unlike the plants in the control condition. In other words, the application of the slurry according to the invention makes it possible for the plant to adapt its water consumption and not to undergo the deleterious effects of water stress.

In addition, it is apparent from these data that for the same initial W/R soil level, the treated plant optimizes its water consumption. The moment when the W/R reaches the wilting point is therefore delayed in the absence of a new water supply, and the plant will remain in its water comfort zone for a longer period. This phenomenon is not associated with a reduction in the yield of the treated modality.

3/ Evaluation of the Capacity of the Slurry According to the Invention to Reduce the Sensitivity of Corn in Cultivation to Water Stress

3.1/ Materials and Methods

The experimental protocol previously explained (soybean assay; Example 2) is reproduced on corn, with the conditions presented in Table 6.

TABLE 6

| Assay | Corn assay | |
|---|---|---|
| Culture (Variety) | Corn (DKC 4670) | |
| Seed density | 88,000 | g/ha |
| Set-up | Bands (1.2 ha) | |
| Dose tested | 5 | L/ha |
| Application stage | BBCH 18 | |
| Method of application | Foliar spray | |
| Volume of slurry | 80 | L/ha |

| | |
|---|---|
| Climatic conditions during | temperature at 21° C., hygrometry |
| application | at 75%, and absence of wind. |

3.2/ Presentation of the Results

The data are collected and processed according to the methodology presented in Example 2. The results obtained are presented in Table 7.

TABLE 7

| W/R variation study | | | |
|---|---|---|---|
| period | 24 Hrs. | 10:00 - 20:20 | 20:40 - 9:40 |
| Slurry according | −4.51 | −3.40 | −1.28 |
| to the invention | | | |
| Control | −5.48 | −4.07 | −1.46 |
| ANOVA | Verified | Verified | Verified |
| Student test p-value | 0.00924 | 0.04329 | 0.06951 |
| Conclusion (at the | Significant | Significant | Insignificant |
| threshold of 5%) | reduction | | (significance |
| | of 16 to 18% | | threshold of 10%) |

The yield analysis shows no significant difference between the two modalities.

3.3/ Conclusion

According to the same reasoning as for the assay on soybeans (Example 2), this assay on corn demonstrates the effectiveness of the slurry according to the invention for reducing the rate of W/R plant consumption from the soil.

4/ Comparative Test of the Application of the Slurry According to the Invention at Different Stages of Soybean Plantlet Growth:

The objective of this assay is to determine the optimum stage of application of the slurry according to the invention on the soybean crop.

4.1/ Materials and Methods

4.1.1/ Description of the Experimental Plot:

The description of the experimental plot is presented in Table 8.

| Test | Soy test |
|---|---|
| Crop (Variety) | Soy (ES Mentor) |
| Set-up | Bands of 1.4 ha |
| Volume of slurry | 80 L/ha |
| Irrigation | Present (frequency of 7 days) |

4.1.2/ Modalities Tested

The description of the modalities tested is presented in Table 9.

TABLE 9

| | | Dose of base | Application |
|---|---|---|---|
| Modality | Treatment | applied | stage |
| 1 | Untreated Control (UC) | — | — |
| A | Slurry according | 3 L/ha | BBCH 12 |
| | to the invention | | |
| B | Slurry according | 3 L/ha | BBCH 21 |
| | to the invention | | |

4.2/ Presentation of the Results

TABLE 10

| Parameter | A | B |
|---|---|---|
| Vegetative | Greater | Better leaf |
| development | branching | development |

| | |
|---|---|
| Resistance to | Better resistance (physiological |
| water stress | observation: less leaf curl) |

| | | |
|---|---|---|
| Improved yield | +3.8% | +17.8% |
| (vs TNT) | | |

4.3/ Conclusion

The effect of the slurry according to the invention seems optimal when it is applied to soybeans at the BBCH 21 stage. The effects observed are a stimulation of the development of the foliar system, a better resistance to water stress, and an improved yield.

5/ Use of the slurry according to the invention as a stimulator of the germination and growth of young sorghum seedlings under controlled and optimal cultivation conditions. The objective of this assay is to evaluate the maintenance of the effect of the slurry according to the invention for stimulating the germination and growth of young sorghum seedlings.

5.1/ Materials and Methods

The protocol consists of priming the sorghum seeds in a slurry containing the base according to the invention before culturing in a petri dish for the germination base. The base according to the invention is replaced by water in the priming solution for the untreated control. The crop parameters are shown in Table 11.

Parameter

| | |
|---|---|
| Crop (Variety) | Sorghum (Belugga variety), seeds supplied |
| | by RAGT |
| Initial experimental | Petri dishes, containing 2 sheets of |
| set-up | Whatman paper and 6 mL of water |
| Size of the Petri dishes | 9 cm in diameter |
| Number of seeds per | 50 seeds per Petri dish |
| dish | |
| Number of blocks | 4 Petri dishes per modality |
| Number of assays | 4 assays (this study was performed 4 times) |
| Tested doses of the | 1 dose tested: 3% of the base according to the |
| slurry according | invention |
| to the invention | |
| Mode of application of | Soaking the seeds in the solution (priming) for |
| the solution according | 15 min in the 3% solution, then drying for |
| to the invention | several days on absorbent paper before |
| | culturing in the Petri dishes |
| Number of applications | 1 |
| Date of priming | 1^{st} day of cultivation |
| Germination conditions | Germination chamber: 25° C., continuous |
| | darkness |

The seeds are cultivated for 7 days. Every 24 hours after sowing (DO), the following parameters were observed:
Percentage of germinated seeds;
Radicle length in mm

5.2/ Results and Conclusion

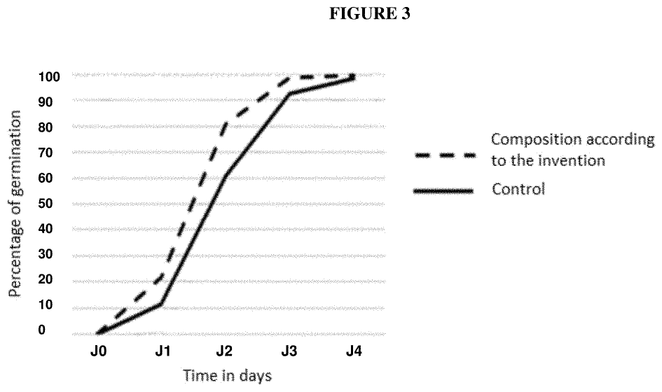

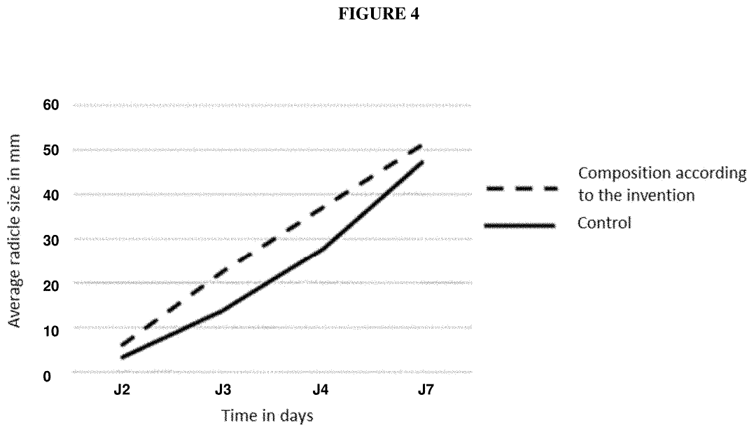

The results are shown in FIGS. 3 and 4. For the entire assay, the sorghum seeds which have been treated by soaking in a 3% solution of the base according to the invention germinate more quickly than those of the control batch. Depending on the experimental conditions, the germination rate is improved by approximately 8 hours for the treated batch compared to the control batch. This is confirmed by measuring the growth of the radicle: the size of the radicle of the treated seeds is markedly larger (1.9 times more on day 2).

6/ Evaluation of the Capacity of the Slurry According to the Invention to Reduce the Sensitivity of the Vine in Cultivation (Young Leaves, Old Leaves and Clusters) to Mildew

The objective of this assay is to demonstrate the effectiveness of the slurry according to the invention in making the plant more resistant to biotic stress.

6.1/ Materials and Methods

6.1.1/ Description of the Experimental Plot:

The description of the experimental plot is presented in Table 12.

TABLE 12

| Test | Vine test | |
|---|---|---|
| Crop (Variety) | Vine (Ugni blanc) | |
| Inter-row | 3 | meters |
| Inter-vines | 1.2 | meters |
| Experimental set-up | Micro plots of 7 vines, 4 repetitions | |
| Particularities | Artificial contamination | |
| Slurry dose tested | 1 | L/ha |

6.1.2/ Modalities Tested

The description of the modalities tested is presented in Table 13.

TABLE 13

| | | Dose of Base | Application |
|---|---|---|---|
| Modality | Treatment | Applied | stage |
| 1 | Untreated control | — | — |
| 2 | Slurry according | 1 L/ha | 7 applications from the |
| | to the invention | | visible cluster stage |
| | | | (BBCH 53) to the pea |
| | | | stage (BBCH 75) |

6.1.3/ Data Collection Method 6.1.3.1/ Measurement of Disease Development

The development of disease is assessed using two complementary indicators:
Disease frequency: percentage of leaves upon which the disease is found; and
Disease intensity (in %): Average disease intensity on all leaves. Thus, the intensity on a leaf corresponds to the area of the leaf covered by the disease (%).

The evaluation is carried out on young leaf, old leaf and cluster. For each organ, the sample is from 200 individuals per modality (50 per microplot).

6.1.3.2/ Statistical Analyses

For this assay, the tests performed are:
A Chi² test of equal frequencies (Equal Means); and
A Mann-Whitney-Wilcoxon test of intensity equality (Equal Means).

6.1.4/ Presentation of the Results

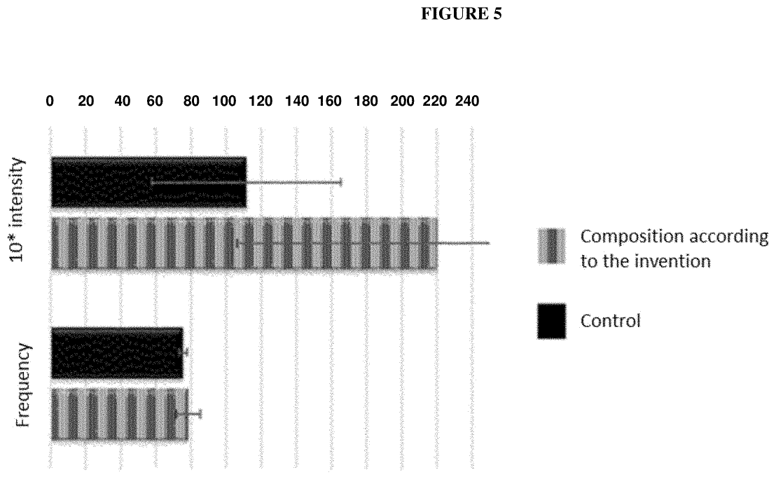

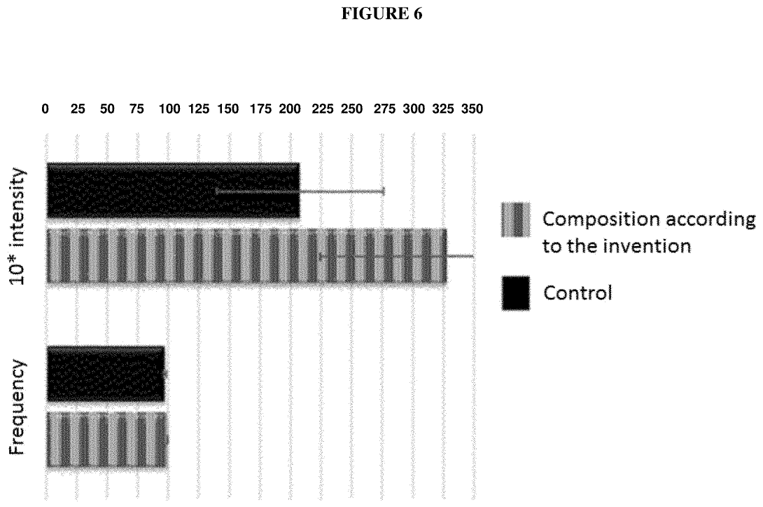

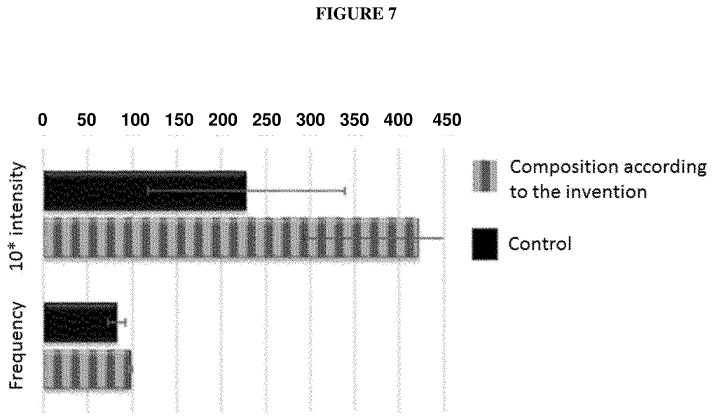

The results of the tally on young leaves, old leaves and clusters are shown in FIGS. 5, 6 and 7, respectively.

6.1.4.1/ Test of Equal Frequencies (Chi²)

TABLE 14

| | Frequency on | Frequency on | Frequency on |
|---|---|---|---|
| Modality | young leaves | old leaves | clusters |
| Slurry according | 75.5% | 97.5% | 82% |
| to the invention | | | |
| Control | 78.5% | 100% | 98% |
| Equal means | Accepted | Inappropriate test | Rejected |
| p-value of test | 0.4759 | | 8.697e−8 |

Conclusion: the effects of the slurry according to the invention on the disease intensity are not significant on the leaves, but the disease is significantly less frequent on the clusters treated beforehand.

6.1.4.2/ Test of Equal Means of Intensities (Mann-Whitney-Wilcoxon)

TABLE 15

| | Intensity on | Intensity on | Intensity on |
|---|---|---|---|
| Modality | young leaves | old leaves | clusters |
| Slurry according | 11.17% | 20.76% | 27.9% |
| to the invention | | | |
| Control | 21.87% | 30.2% | 45.6% |
| Equality of medians | Rejected | Rejected | Rejected |
| Student test p-value | 1.90e−7 | 2.616e−8 | 1.458e−11 |

Conclusion: on the 3 organs observed, the intensity of the disease is significantly lower on the vines having benefited from the solution according to the invention, compared to the same organs of the control method. In this assay, the intensity of the disease may be reduced by 30% to 50% by applying the slurry according to the invention to the vine.

7/ Conditions of Use of the Slurry According to the Invention by Foliar Spraying

The preventive treatment method according to the invention makes it possible to induce an improvement in the vigor of the plant to enable it to fight effectively against abiotic and/or biotic stress. The mixture according to the invention must be applied at the inter-row coverage stage through the leaves of the plant (row sowing crop cultivation).

It emerges from the foregoing that the moment the slurry according to the invention is applied depends on the species of cultivated plant, its vegetative growth, the date of sowing and the distance of the inter-row or herbaceous part between 2 rows of seedlings.

These data are shown in Table 19 for a crop of corn, soybeans and protein seeds.

| | | | | | | | Spray | | | Stage of | Stage of |
|---|---|---|---|---|---|---|---|---|---|---|---|
| | Dose per intake | | Number of | | Dilution volume | | concentration | | | crop at | BBCH crop |
| | (in L/ha) | | intakes per year | | (in liters) | | (in kg/100 L) | | Intake | the time | at the time |
| Crop | Min. | Max. | Min. | Max. | Min. | Max. | Min. | Max. | period | of intake | of intake |
| Corn | 1 | 5 | 1 | 3 | 50 | 200 | 0.5 | 10 | June | 4 to 10 | 14-19 |
| | | | | | | | | | | leaves | |
| Soy | 1 | 5 | 1 | 3 | 50 | 200 | 0.5 | | June | 4 | |
| | | | | | | | | | | flowering | |
| | | | | | | | | | | leaves | |
| Protein | | | | | | | | | | 4 | |
| Seeds | | | | | | | | | | flowering | |
| | | | | | | | | | | leaves | |

1. A method of preventive treatment of a cultivated plant to limit the loss of dry matter linked to abiotic stress, consisting of applying to the plant, before the appearance of said abiotic stress, a slurry comprising:
water; and
a base comprising at least one surfactant and a mixture of phytosterols comprising β-sitosterol.

2. The method according to claim 1, characterized in that the abiotic stress is water stress.

3. The method according to claim 1, characterized in that the abiotic stress is heat stress.

4. The method according to claim 1, characterized in that the β-sitosterol represents at least 30% by mass of the slurry of phytosterols and in that the mass ratio of the phytosterols/surfactants mixture comprises between 0.01 and 5; advantageously between 0.1 and 2.5.

5. A method of preventive treatment of a cultivated plant to limit the loss of dry matter linked to biotic stress, consisting of applying, before the appearance of said biotic stress, a slurry comprising:
water; and
a base comprising at least one surfactant; and a mixture of phytosterols comprising at least 30% by mass of the mixture of β-sitosterol;
wherein the mass ratio of the mixture of phytosterols/surfactant being between 0.01 and 5;
advantageously between 0.1 and 2.5.

6. The method according to claim 5, characterized in that the biotic stress results from a fungal, bacterial, viral infection, pest damage and/or competition with weeds.

7. The method according to claim 1, characterized in that the application of the slurry is by foliar spraying and/or irrigation and/or soaking of the seed.

8. The method according to claim 1, characterized in that the cultivated plant is a chlorophyll plant, advantageously selected from the group comprising the plants of large crops of cereals, oilseeds and protein crops; viticulture; roots and tubers; horticulture; sod; vegetable gardens; aromatics and spices; arboriculture or industrial cultivation of plants intended for the production of a raw material with a view to its transformation.

9. The method according to claim 1, characterized in that the cultivated plant is selected from the group comprising soybeans, corn, barley, millet, Hungarian grass, miscanthus, panicum, sorghum, peanuts, wheat, rapeseed, sunflower, protein peas, field peas, field beans, lupine, flax, truncated alfalfa, grapes, beets, potatoes, beans, lettuce, parsley, rice, radishes, fruit trees and ornamental plants.

10. The method according to claim 4, characterized in that the 100% supplement to the phytosterol mixture optionally comprises campesterol, stigmasterol and brassicasterol.

11. The method according to claim 1, characterized in that the at least one surfactant is selected from the group comprising anionic surfactants, advantageously those whose polar head is a carboxylate, a sulfonate or a sulfated alcohol; cationic surfactants, advantageously those whose polar head is an amine, a quaternary amine or a quaternary ammonium ester; amphoteric surfactants, advantageously betaine or phospholipid derivatives; and neutral surfactants, advantageously ethoxylates, alkanolamines, alkylglucamides, polyol esters, alkyl-mono and alkyl-poly-polyglucosides or polyol ethers; natural surfactants, advantageously soy lecithin or surfactants derived from amino acids; and/or surfactants synthesized from natural raw materials, advantageously polyol derivatives, preferably sugar and fatty acid esters; preferably, the sugar and fatty acid esters are sucrose stearate, sucrose palmitate and their polyesters.

12. The method according to claim 1, characterized in that:
the mixture of phytosterols further comprises campesterol, stigmasterol and brassicasterol; and
the at least one surfactant comprises sucrose stearate, advantageously a mixture comprising sucrose stearate and sucrose palmitate.

13. The method according to claim 1, characterized in that the slurry is applied by foliar spraying at a rate of 0.1 L/ha to 15 L/ha, advantageously at a rate of 1 L/ha to 5 L/ha.

14. A slurry implemented by the method according to claim 1, characterized in that it comprises:
water; and
a base comprising at least one surfactant and a mixture of phytosterols comprising β-sitosterol.

15. The slurry according to claim 14, characterized in that the base represents between 1 ppm and 20% by mass of said slurry, advantageously between 1 ppm and 10%, the complement to 100% being water or a mixture comprising water and one or more active ingredients.

16. A base for the manufacture of the slurry according to claim 14 in the form of an oil-in-water emulsion the particle size of which is less than 500 μm comprising:
an aqueous phase representing between 60% and 95% by mass of the base;
an oily phase representing between 5% and 40% by mass of the base comprising:
at least one surfactant; and
a mixture of phytosterols comprising β-sitosterol,
wherein the mass ratio of the phytosterol/surfactant mixture being between 0.01 and 5, advantageously between 0.1 and 2.5.

17. The base according to claim 16, characterized in that the phytosterol mixture represents between 0.5% and 10% by mass of the base, advantageously between 0.5% and 7%, preferably between 1% and 5%.

18. The base according to claim 16, characterized in that the surfactant represents between 0.2% and 30% by mass of the base, advantageously between 1% and 20%, preferably between 2.5% and 15%.

19. The base according to claim 16, characterized in that the surfactant is a mixture comprising:
between 20% and 80% by mass of the surfactant, advantageously 70%, of sucrose stearate, the monoester content of which is between 20% and 80% by mass of the sucrose stearate, advantageously 70%, the remainder being a mixture of di-, tri- and/or polyesters; and/or
between 20% and 80% by mass of the surfactant, advantageously 30%, of sucrose stearate, the monoester content of which is between 20% and 80% by mass of the sucrose stearate, advantageously 30%, the remainder being a mixture of di-, tri- and/or polyesters.

20. The base according to claim 16, characterized in that it further comprises at least one component selected from the group comprising:
at least one fluidifying agent chosen from the group comprising a polyethylene glycol with an average molecular weight of between 200 and 8000 Da, advantageously between 200 and 1000 Da, preferably 400 Da; the fluidifying agent advantageously represents between 1% and 15% by mass of the base, advantageously between 2% and 8%;
at least one phytosterol solubilizer agent selected from the group comprising oleic alcohol; oleic acid; linoleic acid and a vegetable oil, advantageously soybean oil, sea buckthorn oil, corn oil, rapeseed oil, sunflower oil; the solubilizing agent advantageously represents between 2 and 30% by mass of the base, advantageously between 4 and 15%;
at least one wetting agent selected from the group comprising a mixture of methyl esters advantageously comprising methyltetradecanoate, methyloctadecanoate and methylhexadecanoate, the wetting agent advantageously represents between 0.1% and 5% by mass of the base;
at least one chelating agent, selected from the group comprising natural chelating agents, advantageously sodium phytate or chelating agents based on amino acids; and synthetic chelating agents, advantageously 2,2′-bipyridine, dimercaptopropanol, ethylene glycol-bis-(2-aminoethyl)-N,N,N′,N′-tetraacetic acid, ethylenediaminetetraacetic acid, nitrilotriacetic acid, iminodiacetic acid, salicylic acid or also triethanolamine, preferably EDTA; the chelating agent advantageously represents between 0.01% and 5% by mass of the base; and/or
at least one preservative selected from the group consisting of benzyl alcohol, benzoic acid, dehydroacetic acid, salicylic acid, sorbic acid and one of their salts, advantageously benzyl alcohol; the preservative advantageously represents between 0.1% and 5% by mass of the base.
